(19) United States
(12) Patent Application Publication
(10) Pub. No.: US 2026/0312773 A1
(43) Pub. Date: Oct. 8, 2026

(54) RESOURCE BLOCK ALLOCATION MESSAGING FOR FRONTHAUL OPTIMIZATION

(71) Applicant: QUALCOMM Incorporated, San Diego, CA (US)

(72) Inventors: Akashnil ROY, Kolkata (IN); Tushar SINGH, Hyderabad (IN); Subhanshu SAHU, Delhi (IN)

(21) Appl. No.: 19/098,827

(22) Filed: Apr. 2, 2025

(51) Int. Cl. H04L 5/00

(52) U.S. Cl. CPC H04L 5/0094; H04L 5/0044

(57) ABSTRACT

Aspects relate to a wireless communication system for wireless communication. The wireless communication system may include a Radio Access Network (RAN) entity. The RAN entity may allocate a plurality of resource block groups (RBGs) for at least one channel within a slot. The slot may comprise a plurality of symbols. The plurality of RBGs may comprise a plurality of resource block (RB) segments that spans the plurality of symbols. The RAN entity may generate an RB allocation message that indicates, on a per symbol basis in the slot, at least one RB segment of the plurality of RB segments and transmit the RB allocation message.

### BACKGROUND

### Field of the Disclosure

The present disclosure relates generally to wireless communication systems, and, more particularly, to resource block allocation messaging in open radio access networks.

### Description of Related Art

Wireless communication systems are widely deployed to provide a range of communication services, including telephony, data transmission, messaging, multimedia streaming, broadcasting, or the like. The wireless communication systems may enable communication among multiple users by employing various multiple-access technologies. For example, the multiple-access technologies may include Code Division Multiple Access (CDMA), Time Division Multiple Access (TDMA), Frequency Division Multiple Access (FDMA), Orthogonal Frequency Division Multiple Access (OFDMA), or the like. Examples of wireless multiple-access communication systems may include fourth-generation (4G) systems such as Long-Term Evolution (LTE) systems, LTE-Advanced (LTE-A) systems, or LTE-A Pro systems, and fifth-generation (5G) systems which can be referred to as New Radio (NR) systems.

A wireless multiple-access communication system may include one or more base stations that facilitate wireless communication for communication devices such as User Equipment (UE). The wireless communication between a base station and a UE may occur over one or more communication channels. The communication channels may include one or more uplink channels for transmitting data from the UE to the base station and/or one or more downlink channels for transmitting data from the base station to the UE. Some wireless multiple-access communication systems may incorporate resource block (RB) pooling, where RBs can be dynamically allocated in pools to one or more UEs, to enhance communication efficiency. The resource blocks can correspond to communication resources, such as bandwidth, time, and/or frequency, used to carry data over the communication channels.

In the context of an Open Radio Access Network (O-RAN) architecture, functions of a base station may be distributed across multiple devices or components. For example, a Radio Access Network (RAN) entity within the O-RAN architecture may include at least one of a Central Unit (CU), a Distributed Unit (DU), or a Radio Unit (RU). The RU may handle radio frequency (RF) communications with a UE, while the CU and/or DU may support the RF communications performed by the RU. In an example, the CU and/or DU may handle higher-layer processing (for example, managing the resource block pooling) to support the RF communications. However, with the increasing demand for enhanced network performance, such as lower latency, increased network efficiency, or the like, there are opportunities to optimize information pertaining to the resource block pooling that is communicated among one or more RAN entities of the O-RAN architecture to ensure seamless wireless communication.

### SUMMARY

Aspects of the disclosure provide a Radio Access Network (RAN) entity for wireless communication. The RAN entity includes one or more memories and one or more processors coupled to the one or more memories. The one or more processors individually or collectively are configured to cause the RAN entity to allocate a plurality of resource block groups (RBGs) for at least one channel within a slot. The slot comprises a plurality of symbols. The plurality of RBGs comprises a plurality of resource block (RB) segments spanning the plurality of symbols. Further, the one or more processors are individually or collectively further configured to cause the RAN entity to generate an RB allocation message that indicates, on a per symbol basis in the slot, at least one RB segment of the plurality of RB segments. Furthermore, the one or more processors are individually or collectively further configured to cause the RAN entity to transmit the RB allocation message.

In some aspects of the disclosure, a RAN entity for wireless communication is provided. The RAN entity includes one or more memories and one or more processors coupled to the one or more memories. The one or more processors are individually or collectively configured to cause the RAN entity to receive, for at least one channel in a slot, a resource block (RB) allocation message that indicates, on a per symbol basis in the slot, at least one RB segment of a plurality of RB segments allocated to the at least one channel. The slot comprises a plurality of symbols. The plurality of RB segments spans the plurality of symbols. Further, the one or more processors are individually or collectively further configured to cause the RAN entity to generate one or more control plane (C-plane) messages for the at least one channel based on the RB allocation message. Furthermore, the one or more processors are individually or collectively further configured to cause the RAN entity to transmit the one or more C-plane messages.

In some more aspects of the disclosure, a resource block (RB) allocation method in a Radio Access Network (RAN) entity is provided. The RB allocation method includes allocating a plurality of resource block groups (RBGs) for at least one channel within a slot. The slot comprises a plurality of symbols. The plurality of RBGs comprises a plurality of RB segments spanning the plurality of symbols. Further, the RB allocation method includes generating an RB allocation message that indicates, on a per symbol basis in the slot, at least one RB segment of the plurality of RB segments. Furthermore, the RB allocation method includes transmitting the RB allocation message.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of an Open Radio Access Network (O-RAN) architecture, in accordance with certain aspects of the present disclosure;

FIG. 2 is a diagram that illustrates an example of an O-RAN for fronthaul optimization, in accordance with certain aspects of the present disclosure;

FIG. 3 is a diagram that illustrates an example of a message flow for the fronthaul optimization, in accordance with certain aspects of the present disclosure;

FIG. 4 is a diagram that illustrates an example of an O-RAN for the fronthaul optimization, in accordance with certain aspects of the present disclosure;

FIG. 5 is a diagram that illustrates a flowchart of a process (e.g., a method) for transmitting a resource block (RB) allocation message, in accordance with certain aspects of the present disclosure;

FIG. 6 is a diagram that illustrates a flowchart of a process (e.g., a method) for transmitting one or more RB allocation messages, in accordance with certain aspects of the present disclosure;

FIG. 7 is a diagram that illustrates a flowchart of a process (e.g., a method) for performing one or more control plane (C-plane) and/or user plane (U-plane) communications, in accordance with certain aspects of the present disclosure;

FIG. 8 is a diagram that illustrates a flowchart of a process (e.g., a method) for transmitting one or more C-plane messages, in accordance with certain aspects of the present disclosure; and

FIG. 9 is a diagram that illustrates an example of a Radio Access Network (RAN) entity, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

An Open Radio Access Network (O-RAN) architecture may enable base station functionalities to be distributed across multiple devices or components. For example, a Radio Access Network (RAN) node within the O-RAN architecture may include at least one of a Central Unit (CU), a Distributed Unit (DU), or a Radio Unit (RU). The RU may handle radio frequency (RF) communications with communication devices such as user equipment (UEs), while the CU and/or DU may support and manage the RF communications performed by the RU. While the distribution of the base station functionalities allows for flexibility and scalability, the distribution may involve an exchange of information between the RAN nodes to maintain optimal network performance.

One such interaction within the O-RAN architecture may involve transmitting, from the DU to the RU, a control plane (C-plane) message that specifies resource block (RB) allocation for the UEs. In some implementations, to enhance the efficiency of the RB allocation, the CU or DU may implement dynamic RB allocation techniques, such as RB pooling. For example, in RB pooling, RBs may be dynamically allocated to the UEs from a resource pool based on several factors, such as network conditions, UE-specific requirements, service requirements, or the like. However, due to the dynamic nature of the RB allocations, the allocated RBs may have varying time durations, which can lead to unallocated RBs within the resource pool.

To manage these variations, some implementations propose transmitting information pertaining to the resource pool via the C-plane message while communicating the unallocated RBs via a user plane (U-plane) message. However, when the variation of the time durations becomes substantial, the dependency on the U-plane messaging can introduce communication overhead, such as consuming additional bandwidth, increasing latency, or the like, which in turn may impact overall network performance. Accordingly, there are opportunities to optimize the C-plane messaging and the U-plane messaging to improve the network performance.

Certain aspects disclosed herein provide systems and methods for RB allocation messaging for fronthaul optimization. In one aspect, a RAN entity (also, referred to as a network entity, a network node, or a RAN node) for the RB allocation messaging is provided. The RAN entity may be configured to operate at a Medium Access Control (MAC) layer of a communication protocol stack and/or a first physical layer (e.g., a high-physical layer) of the communication protocol stack. At the MAC layer, the RAN entity may execute one or more dynamic RB allocation processes (e.g., an RB pooling process) for a slot. Upon executing the RB pooling process, the RAN entity may identify a pool of available RBs for the slot. In various examples, the pool of available RBs may include a plurality of RBs that are available for allocation within the slot. As used herein, the slot may refer to (or represent) a time unit that includes a plurality of symbols distributed across multiple sub-carriers.

The RAN entity may allocate, among the pool of available RBs within the slot, a plurality of resource block groups (RBGs) for at least one channel. In various examples, the plurality of RBGs may include a plurality of RB segments that spans the plurality of symbols included in the slot. In numerous examples, the at least one channel may include (or correspond to) a Physical Downlink Control Channel (PDCCH), a Physical Uplink Control Channel (PUCCH), a Physical Downlink Shared Channel (PDSCH), a Physical Uplink Shared Channel (PUSCH), a Control Resource Set (CORESET), or the like. The RAN entity may further generate an RB allocation message for the at least one channel. In numerous examples, the RB allocation message may indicate, on a per symbol basis in the slot, at least one RB segment of the plurality of RB segments. The RAN entity may then transmit the RB allocation message.

Advantageously, the transmission of the RB allocation message that indicates, on the per symbol basis in the slot, the at least one RB segment of the plurality of RB segments may enable the RAN entity to transmit C-plane messages that specify the plurality of RB segments allocated for the at least one channel. Since the C-plane messages specify the plurality of RB segments allocated for the at least one channel, the transmission of the C-plane messages may enable the RAN entity to transmit U-plane message(s) in which unallocated RB segment information for the at least one channel is absent. In other words, the transmission of the C-plane messages may enable the RAN entity to prohibit the transmission of U-plane message(s) that include the unallocated RB segment information for the at least one channel. Consequently, the communication overhead in the fronthaul interface may be reduced which in turn can assist in improving the network performance, such as reducing network latency, increasing network bandwidth, or the like.

In some examples, the RB allocation message may indicate, on the per symbol basis in the slot, the at least one RB segment as a function of a first RB segment limit and a second RB segment limit. In an example, the first RB segment limit and the second RB segment limit may correspond to a minimum RB segment limit and a maximum RB segment limit, respectively, where the minimum RB segment limit can indicate a first sub-carrier value at which a specific RB segment starts and the maximum RB segment limit can indicate a second sub-carrier value at which the specific RB segment ends. Thus, in an example scenario if the plurality of RBGs for the at least one channel is distributed across 10 symbols in the slot, the RB allocation message may indicate 10 RB segments, with each RB segment corresponding to a single symbol and defined by minimum and maximum sub-carrier values. The minimum and maximum sub-carrier values for these 10 RB segments can vary based on varying time durations of the plurality of RBGs.

In numerous examples, the RB allocation message may be transmitted from the MAC layer to the first physical layer. In some examples, the RAN entity may include a Functional Application Platform Interface (FAPI) that is configured to communicatively couple the MAC layer to the first physical layer. In these examples, the RB allocation message may be transmitted via the FAPI. In some more examples, the RB allocation message may correspond to an RB aggregation Protocol Data Unit (PDU) in a FAPI message that is transmitted in the FAPI. In an example, the FAPI message may correspond to at least one of a Downlink Transmission Time Interval (DL TTI) request message, an Uplink Downlink Control Information (UL DCI) message, an Uplink Transmission Time Interval (UL TTI) request message, or the like.

At the first physical layer, upon receiving the RB allocation message, the RAN entity may generate one or more C-plane messages for the at least one channel. In numerous examples, the RAN entity may generate the C-plane messages based on the RB allocation message. In some examples, the generation of a C-plane message of the C-plane messages may be for one of: one symbol in the slot or two or more symbols, in the slot, that are associated with corresponding RB segments, of the plurality of RB segments, having same first RB segment limits and same second RB segment limits. In various examples, the C-plane messages may collectively specify the plurality of RB segments allocated to the at least one channel.

Upon generating the C-plane messages, the RAN entity may transmit the C-plane messages. In numerous examples, the C-plane messages may be transmitted from the first physical layer to a second physical layer (e.g., a low-physical layer) of the communication protocol stack. In several examples, the RAN entity may transmit the C-plane messages to a RAN entity that is operating at the second physical layer. In various examples, the C-plane messages may be transmitted via a fronthaul interface.

Upon transmitting the C-plane messages, the RAN entity may generate a U-plane message for the at least one channel. In various examples, the U-plane message may specify user data for one or more communication devices, such as UEs. In further examples, since the C-plane messages specify the plurality of RB segments allocated for the at least one channel, the U-plane message may not specify unallocated RB segment information for the at least one channel. Accordingly, the RAN entity may generate the U-plane message in such a way that the U-plane message is optimized to not include (or not indicate) the unallocated RB segment information for the at least one channel.

Upon generating the U-plane message, the RAN entity may transmit the U-plane message in which the unallocated RB segment information is absent. In numerous examples, the U-plane message may be transmitted from the first physical layer to the second physical layer. In several examples, the U-plane message may be transmitted to the second physical layer via the fronthaul interface.

In further aspects, the RAN entity may transmit a symbol enable indicator. In numerous examples, the symbol enable indicator may be transmitted from the MAC layer to the first physical layer. In several examples, the symbol enable indicator may correspond to a flag in the RB allocation message to specify whether the RB allocation message indicates the at least one RB segment on the per symbol basis in the slot. In an example, the symbol enable indicator may have a first configured value (e.g., a Boolean value of ‘1’) to specify that the RB allocation message indicates the at least one RB segment on the per symbol basis in the slot. Additionally, or alternatively, the symbol enable indicator may have a second configured value (e.g., a Boolean value of ‘0’) to specify that the RB allocation message does not indicate the at least one RB segment on the per symbol basis in the slot. Accordingly, by transmitting the symbol enable indicator, the first physical layer can be made aware of whether the RB allocation message indicates the at least one RB segment on the per symbol basis in the slot or not. As a result, at the first physical layer, the RAN entity may operate without performing additional checks, such as determining whether the RB allocation message indicates the at least one RB segment on the per symbol basis in the slot. Accordingly, the demand for computation resources of the RAN entity may be reduced.

In additional aspects, the RAN entity may transmit a capability indicator. In numerous examples, the capability indicator may be transmitted from the first physical layer to the MAC layer. In several examples, the capability indicator may specify whether the first physical layer supports the RB allocation message that indicates the at least one RB segment on the per symbol basis in the slot. In an example, the capability indicator may have a first configured value (e.g., a Boolean value of ‘1’) to specify that the first physical layer supports the RB allocation message. Additionally, or alternatively, the capability indicator may have a second configured value (e.g., a Boolean value of ‘0’) to specify that the first physical layer does not support the RB allocation message. Accordingly, by transmitting the capability indicator, the MAC layer can be made aware of whether the first physical layer supports the RB allocation message that indicates the at least one RB segment on the per symbol basis in the slot.

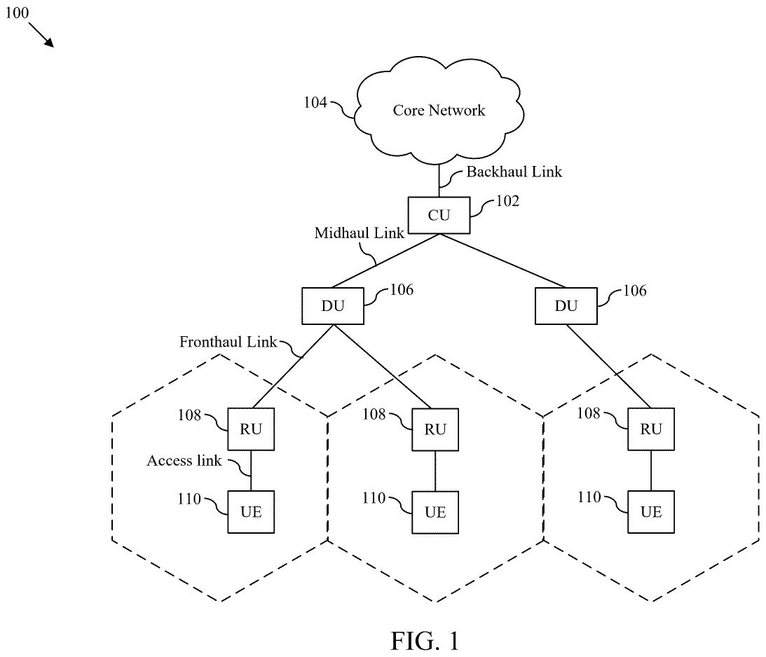

FIG. 1 is a diagram that illustrates an example of an Open Radio Access Network (O-RAN) architecture 100, in accordance with certain aspects of the present disclosure. In various aspects, the O-RAN architecture 100 may be implemented by one or more network nodes of a wireless communication system. In an example, the wireless communication system may include a fourth-generation (4G) system, a fifth-generation (5G) system, a future-generation system (e.g., a sixth-generation “6G” system), or the like. For example, a network node of the network nodes may include a New Radio (NR) base station, a Long-Term Evolution (LTE) base station, a Node B, an Evolved Node B (eNB), a Next Generation Node B (gNB), a Radio Access Network (RAN) node, an access point, a transmission-reception point (TRP), a mobile entity of a wireless communication network, or the like.

In a non-limiting example shown in FIG. 1, the O-RAN architecture 100 may include a Central Unit (CU) 102 that is communicatively coupled to a core network 104 via a backhaul link. In an example, the CU 102 may be implemented within the network node of the one or more network nodes. Further, the O-RAN architecture 100 may include one or more Distributed Units (DUs) 106 and one or more Radio Units (RUs) 108. Each of the DUs 106 may be communicatively coupled to the CU 102 via a respective midhaul link. Further, each of the DUs 106 may be communicatively coupled to at least one corresponding RU of the RUs 108 via at least one respective fronthaul link. The DUs 106 may be co-located with the CU 102, or alternatively, may be distributed across different network nodes. Each of the RUs 108 may be co-located with a corresponding DU of the DUs 106, or alternatively, may be distributed across at least one network node of the network nodes. Further, each of the RUs 108 may be communicatively coupled to at least one corresponding User Equipment (UE) 110 via a respective radio frequency (RF) access link. Examples of the UE 110 may include a cellular phone, a personal digital assistant (PDA) device, a wireless modem, a wireless communication device, a handheld device, a laptop computer, a wireless local loop (WLL) station, a tablet, a camera, a gaming device, a wearable device, or the like.

In various aspects, the CU 102 may host a first set of higher-layer functions for network control and/or signaling. In some examples, the CU 102 may host the first set of higher-layer functions depending, at least in part, on a functional split, such as a functional split defined by the 3rd Generation Partnership Project (3GPP). In some more examples, the first set of higher-layer functions may include one or more functions implemented at a Layer 2 (L2) of a communication protocol stack, a Layer 3 (L3) of the communication protocol stack, and/or layers higher than a Layer 1 (L1) (also referred to as the physical layer) of the communication protocol stack. In an example, the first set of higher-layer functions may include a Radio Resource Control (RRC) function, a Packet Data Convergence Protocol (PDCP) function, a Service Data Adaptation Protocol (SDAP) function, a Radio Link Control (RLC) function, a Medium Access Control (MAC) function, or the like.

Each higher-layer function of the first set of higher-layer functions may be implemented with an interface configured to communicate signals with remaining higher-layer functions hosted by the CU 102. Further, the CU 102 may be configured to handle a user plane functionality (e.g., a Central Unit-User Plane (CU-UP) functionality), a control plane functionality (e.g., a Central Unit-Control Plane (CU-CP) functionality), or a combination thereof. In some aspects, the CU 102 may be logically split into one or more CU-UP units and one or more CU-CP units to handle the user plane functionality and the control plane functionality, respectively. In some more aspects, the CU 102 may be implemented to communicate with the DUs 106 for the network control and/or signaling.

Each of the DUs 106 may correspond to a logical unit that includes one or more base station functions to control the operation of the corresponding RU of the RUs 108. In further aspects, each of the DUs 106 may host a second set of higher-layer functions depending, at least in part, on the functional split defined by the 3GPP. In some examples, the second set of higher-layer functions may include one or more functions implemented at a high-physical (high-PHY) layer of the communication protocol stack, the L2, the L3, and/or layers higher than a low-physical (low-PHY) layer of the communication protocol stack. In an example, the second set of higher-layer functions may include a forward error correction (FEC) function, a scrambling function, a modulation function, a demodulation function, the RRC function, the PDCP function, the RLC function, the MAC function, or the like. In some more examples, each higher-layer function hosted by a DU 106 of the DUs 106 may be implemented with an interface that is configured to communicate signals with remaining higher-layer functions hosted by the DU 106, or with the first set of higher-layer functions hosted by the CU 102.

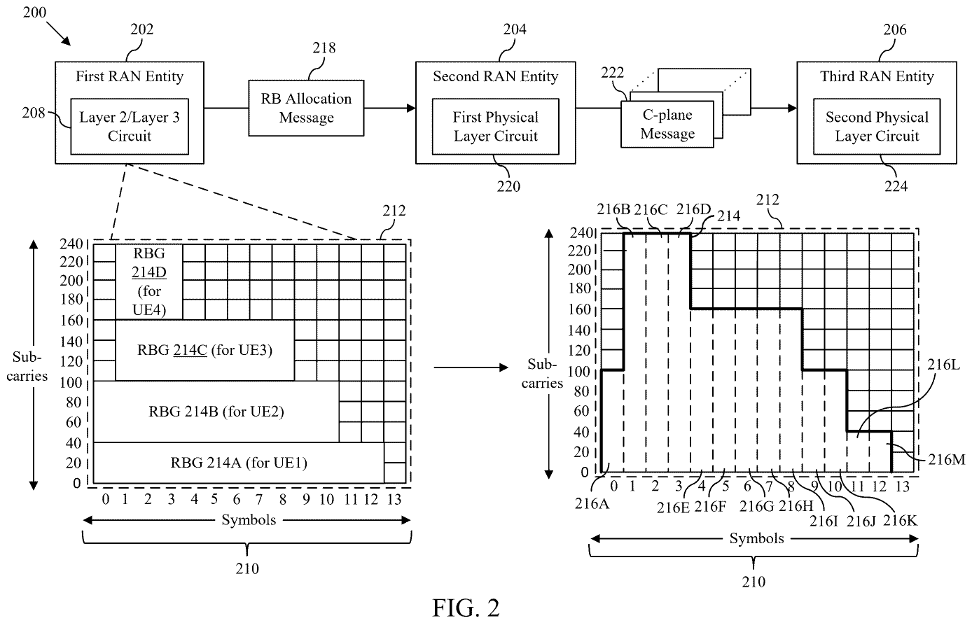

Each of the RUs 108 may host a set of lower-layer functions depending, at least in part, on the functional split defined by the 3GPP. In some examples, the set of lower-layer functions may include one or more low-PHY layer functions supported by the low-PHY layer or one or more RF processing functions. For example, the set of lower-layer functions may include performing a Fast Fourier Transform (FFT), performing an inverse Fast Fourier Transform (iFFT), digital beamforming, or Physical Random-Access Channel (PRACH) extraction and filtering, or the like. In some aspects, each of the RUs 108 may be controlled by the corresponding DU of the DUs 106 to handle over-the-air (OTA) communication with the UE 110. In some more aspects, each of the RUs 108 may be controlled by the CU 102 via the corresponding DU of the DUs 106. In some implementations, to handle the OTA communication, the DUs 106 (or the CU 102) may control one or more real-time, near real-time, or non-real-time aspects of control plane (C-plane) communication (and/or user plane “U-plane” communication) with the RUs 108. For example, the real-time, near real-time, or non-real-time aspects of the C-plane communication, which are controlled by the DUs 106, are explained in conjunction with FIGS. 2-8.

FIG. 2 is a diagram that illustrates an example of an O-RAN 200 for fronthaul optimization, in accordance with certain aspects of the present disclosure. FIG. 2 is explained in conjunction with FIG. 1. In a non-limiting example shown in FIG. 2, the O-RAN 200 may include a first RAN entity 202, a second RAN entity 204, and a third RAN entity 206. In numerous examples, the first RAN entity 202, the second RAN entity 204, and the third RAN entity 206 may correspond to the CU 102, the DU 106, and the RU 108, respectively. In many examples, the first RAN entity 202 may be communicatively coupled to the second RAN entity 204 via a midhaul interface. In some examples, the midhaul interface may correspond to one of: an F1 interface or a Functional Application Platform Interface (FAPI) based on the functional split that is utilized to implement the first RAN entity 202 and the second RAN entity 204. In further examples, the second RAN entity 204 may be communicatively coupled to the third RAN entity 206 via a fronthaul interface, for example, an Enhanced Common Public Radio Interface (eCPRI).

In some aspects, the first RAN entity 202 may include an L2/L3 circuit 208. In various examples, the L2/L3 circuit 208 may correspond to a circuit (e.g., a chipset, a network card, a processor, a microprocessor, or the like) that is configured to implement an L2 protocol associated with the L2, an L3 protocol associated with the L3, or protocols associated with a layer higher than the L1. In some implementations, the L2/L3 circuit 208 may be configured to implement a MAC layer protocol associated with the MAC layer.

In some more aspects, the first RAN entity 202 may be configured to enable the third RAN entity 206 to execute the OTA communication with communication devices, such as the UEs 110. In numerous examples, to enable the third RAN entity 206 to execute the OTA communication, the L2/L3 circuit 208 of the first RAN entity 202 may configure a radio frame to facilitate the OTA communication. For example, the radio frame may be configured to organize (or schedule) user data, control information, synchronization information, and/or additional information for the OTA communication. In various examples, the radio frame may include a plurality of subframes, with each subframe having at least one slot (e.g., a slot 210). The slot 210 may represent a time unit that includes a configurable number of symbols (e.g., Orthogonal Frequency Division Multiple Access “OFDMA” symbols) distributed across multiple sub-carriers. For example, the number of symbols included in the slot 210 may depend, at least in part, on a sub-carrier spacing (SCS), a cyclic prefix (CP) configuration, or the like facilitated by the wireless communication system. In the non-limiting example shown in FIG. 2, the slot 210 may include fourteen symbols (denoted as symbols 0-13).

In further examples, to configure the radio frame for the OTA communication, the L2/L3 circuit 208 may be configured to execute a resource block (RB) pooling process for at least one slot (e.g., the slot 210) in the radio frame. In some examples, the RB pooling process may be executed to identify a pool of RBs that are available for allocation within the slot 210. In the non-limiting example shown in FIG. 2, upon executing the RB pooling process for the slot 210, the L2/L3 circuit 208 may identify an entire resource grid 212 as the pool of RBs that are available for the allocation within the slot 210. For example, the resource grid 212 may include a plurality of RBs that are available for the allocation within the slot 210, where each RB of the plurality of RBs spans a specific number of symbols in the time domain (within the slot 210) and a specific number of sub-carriers in the frequency domain.

Upon identifying the resource grid 212, the L2/L3 circuit 208 may be configured to allocate, among the plurality of RBs that are available within the slot 210, a plurality of resource block groups (RBGs) 214A through 214D for at least one channel between the third RAN entity 206 and the UEs 110. In other words, the L2/L3 circuit 208 may be configured to allocate the plurality of RBGs 214A through 214D to the UEs 110 (e.g., the UE1 through UE4) for the at least one channel. In numerous examples, the plurality of RBGs 214A through 214D may include an RBG allocated to each UE of the UEs 110 for the at least one channel. In the non-limiting example shown in FIG. 2, the plurality of RBGs 214A through 214D may include an RBG 214A, an RBG 214B, an RBG 214C, and an RBG 214D allocated to the UE1, the UE2, the UE3, and the UE4, respectively.

In further examples, each RBG of the plurality of RBGs 214A through 214D may include one or more RBs, of the plurality of RBs, that are allocated to a respective UE of the UEs 110 for the at least one channel. In an example, an RB of the one or more RBs may represent a time-frequency unit that spans (or includes) the specific number of sub-carriers in the frequency domain for the specific number of symbols in the time domain. In various examples, the at least one channel may include (or correspond to) a Physical Downlink Control Channel (PDCCH), a Physical Uplink Control Channel (PUCCH), a Physical Downlink Shared Channel (PDSCH), a Physical Uplink Shared Channel (PUSCH), a Control Resource Set (CORESET), or the like. In other words, an RBG may collectively represent one or more RBs allocated to a UE for a channel.

In furthermore examples, the L2/L3 circuit 208 may allocate the plurality of RBGs 214A through 214D to the UEs 110 by evaluating multiple factors, such as channel requirements and/or UE requirements. In an example, the channel requirements and/or the UE requirements may include one or more channel conditions associated with the at least one channel, a traffic demand associated with the UEs 110, Quality of Service (QoS) requirements associated with the at least one channel (or the UEs 110), or the like. Since the plurality of RBGs 214A through 214D are allocated to the UEs 110 based on, for example, the channel requirements and/or the UE requirements, the plurality of RBGs 214A through 214D may exhibit non-uniform symbol durations instead of adhering to a uniform symbol duration across all RBGs in the plurality of RBGs 214A through 214D. In other words, the plurality of RBGs 214A through 214D may include at least one RBG whose symbol duration differs from the symbol durations of remaining RBGs in the plurality of RBGs 214A through 214D. In an example, the symbol duration of a specific RBG of the plurality of RBGs 214A through 214D may refer to (or represent) a range of symbols that the specific RBG spans within the slot 210. In the non-limiting example shown in FIG. 2, the RBG 214A, the RBG 214B, the RBG 214C, and the RBG 214D may have symbol durations of ‘0-12’, ‘0-10’, ‘1-8’, and ‘1-3’, respectively.

Upon allocating the plurality of RBGs 214A through 214D to the UEs 110, the L2/L3 circuit 208 may be configured to aggregate the plurality of RBGs 214A through 214D to produce an aggregated RBG 214. In some examples, the aggregation of the plurality of RBGs 214A through 214D may include combining the plurality of RBGs 214A through 214D along the frequency domain of the resource grid 212 to produce the aggregated RBG 214. In various examples, the aggregated RBG 214 (or the plurality of RBGs 214A through 214D) may include a plurality of RB segments 216A through 216M that spans a plurality of symbols (e.g., symbols 0-12) included in the slot 210. In other words, the aggregated RBG 214 may include the plurality of RB segments 216A through 216M that are distributed across the plurality of symbols in the slot 210. In the non-limiting example shown in FIG. 2, the plurality of RB segments 216A through 216M may include RB segments 216A, 216B, 216C, 216D, 216E, 216F, 216G, 216H, 216I, 216J, 216K, 216L, and 216M that are distributed across the symbols 0-12, respectively. In an example, each RB segment of the plurality of RB segments 216A through 216M may refer to (or represent) a range of sub-carriers that is allocated to the at least one channel for a respective symbol in the slot 210. In the example scenario shown in FIG. 2, the plurality of RBGs 214A through 214D is 0-12 symbols in the slot 210. In such a scenario, the aggregated RBG 214 may include 13 RB segments 216A, 216B, 216C, 216D, 216E, 216F, 216G, 216H, 216I, 216J, 216K, 216L, and 216M, with each RB segment corresponding to a single symbol.

Upon producing the aggregated RBG 214 (or upon allocating the plurality of RBGs 214A through 214D), the L2/L3 circuit 208 may be configured to generate an RB allocation message 218. In various examples, the RB allocation message 218 may indicate configurational information associated with the at least one slot (e.g., the slot 210) of the radio frame. In some examples, the RB allocation message 218 may indicate the aggregated RBG 214 or the plurality of RBGs 214A through 214D that is allocated for the at least one channel within the slot 210. In some more examples, the RB allocation message 218 may indicate the plurality of RB segments 216A through 216M that are distributed across the plurality of symbols of the slot 210.

In some aspects, to generate the RB allocation message 218, the L2/L3 circuit 208 may be configured to determine at least one RB segment associated with each symbol of the plurality of symbols of the slot 210. In an example, the at least one RB segment associated with each symbol of the plurality of symbols may be determined based on the aggregated RBG 214 or the plurality of RBGs 214A through 214D. Upon determining the at least one RB segment associated with each symbol of the plurality of symbols, the L2/L3 circuit 208 may configure the RB allocation message 218 to include the determined at least one RB segment. Accordingly, the RB allocation message 218 may indicate, on a per symbol basis in the slot 210, the at least one RB segment of the plurality of RB segments 216A through 216M.

In some more aspects, the L2/L3 circuit 208 may be configured to determine the at least one RB segment as a function of a first RB segment limit and a second RB segment limit. In various examples, the first RB segment limit of a specific RB segment and the second RB segment limit of the specific RB segment may specify (or represent) a range of subcarriers that the specific RB segment spans for the corresponding symbol in the slot 210. In some more examples, the first RB segment limit and the second RB segment limit may correspond to a minimum RB segment limit and a maximum RB segment limit, respectively, where the minimum RB segment limit can indicate a first sub-carrier value at which the specific RB segment starts and the maximum RB segment limit can indicate a second sub-carrier value at which the specific RB segment ends. In these aspects, the RB allocation message 218 may indicate, on the per symbol basis in the slot 210, the at least one RB segment as the function of the first RB segment limit and the second RB segment limit. For example, the RB allocation message 218 may indicate the at least one RB segment associated with each symbol of the plurality of symbols as a minPrbSegment [X] and a maxPrbSegment [X], where ‘X’ represents the plurality of symbols in the slot 210 (e.g., ‘X’=0, 1, . . . , 13). In the non-limiting example, the RB allocation message 218 may indicate, on the per symbol basis in the slot 210, the at least one RB segment as follows:

| | |
|---|---|
| minPrbSegment[0]: 0 | minPrbSegment[7]: 0 |
| maxPrbSegment[0]: 100 | maxPrbSegment[7]: 160 |
| minPrbSegment[1]: 0 | minPrbSegment[8]: 0 |
| maxPrbSegment[1]: 240 | maxPrbSegment[8]: 160 |
| minPrbSegment[2]: 0 | minPrbSegment[9]: 0 |
| maxPrbSegment[2]: 240 | maxPrbSegment[9]: 100 |
| minPrbSegment[3]: 0 | minPrbSegment[10]: 0 |
| maxPrbSegment[3]: 240 | maxPrbSegment[10]: 100 |
| minPrbSegment[4]: 0 | minPrbSegment[11]: 0 |
| maxPrbSegment[4]: 160 | maxPrbSegment[11]: 40 |
| minPrbSegment[5]: 0 | minPrbSegment[12]: 0 |
| maxPrbSegment[5]: 160 | maxPrbSegment[12]: 40 |
| minPrbSegment[6]: 0 | minPrbSegment[13]: 0 |
| maxPrbSegment[6]: 160 | maxPrbSegment[13]: 0 |

Upon generating the RB allocation message 218, the first RAN entity 202 may be configured to transmit the RB allocation message 218 to the second RAN entity 204. In an example, the L2/L3 circuit 208 may transmit the RB allocation message 218 to the second RAN entity 204 via the midhaul interface. In some aspects, the second RAN entity 204 may include a first physical layer circuit 220. In various examples, the first physical layer circuit 220 may correspond to a circuit (e.g., a chipset, a network card, a processor, a microprocessor, or the like) that is configured to implement one or more protocols associated with a first physical layer (e.g., the high-PHY layer). In numerous examples, the first physical layer circuit 220 may be configured to receive the RB allocation message 218 from the first RAN entity 202 (e.g., the L2/L3 circuit 208).

Upon receiving the RB allocation message 218, the first physical layer circuit 220 may be configured to generate one or more C-plane messages (collectively referred to as C-plane messages) 222 for the at least one channel. In some examples, the C-plane messages 222 may specify the RB allocations for the at least one channel. In some more examples, the C-plane messages 222 may collectively specify the aggregated RBG 214 or the plurality of RBGs 214A through 214D that is allocated for the at least one channel within the slot 210.

In some aspects, to generate the C-plane messages 222, the first physical layer circuit 220 may be configured to select, within the slot 210, a symbol in a predefined order. In an example, the predefined order may be an order from symbol ‘0’ to symbol ‘13’ or an order from symbol ‘13’ to symbol ‘0’. Upon selecting the symbol, the first physical layer circuit 220 may be configured to determine at least one RB segment associated with the selected symbol. In an example, the at least one RB segment associated with the selected symbol may be determined based on the RB allocation message 218. Upon determining the at least one RB segment associated with the selected symbol, the first physical layer circuit 220 may generate, for the selected symbol, a C-plane message of the C-plane messages 222. In an example, the generated C-plane message may specify the at least one RB segment that is allocated for the at least one channel in the selected symbol.

Further, the first physical layer circuit 220 may select, within the slot 210, a next symbol in the predefined order to generate a next C-plane message of the C-plane messages 222. In this way, the first physical layer circuit 220 may iteratively select the plurality of symbols within the slot 210 to generate the C-plane messages 222 for the plurality of symbols. Accordingly, in these aspects, the first physical layer circuit 220 may generate, for each symbol in the slot 210, a respective C-plane message of the C-plane messages 222. In other words, the generation of the C-plane messages 222 may be on the per symbol basis in the slot 210. In some implementations, if the slot 210 includes one or more unallocated symbols, such as the symbol ‘13’, whose corresponding RBs are entirely unallocated for the at least one channel, the first physical layer circuit 220 may prohibit the generation of a C-plane message for the unallocated symbols while generating the C-plane messages 222.

In some more aspects, to generate the C-plane messages 222, the first physical layer circuit 220 may be configured to determine, based on the RB allocation message 218, one or more combinations of symbols within the slot 210. As used herein, a combination of symbols of the one or more combinations of symbols may refer to (correspond to) two or more symbols that may be consecutive (optional) in the slot 210 and are associated with corresponding RB segments, of the plurality of RB segments 216A through 216M, having same first RB segment limits and same second RB segment limits. For the non-limiting example shown in FIG. 2, the first physical layer circuit 220 may determine, as the one or more combinations of symbols, a first combination of symbols ‘1-3’, a second combination of symbols ‘4-8’, a third combination of symbols ‘9 and 10’, a fourth combination of symbols ‘11 and 12’. As shown in FIG. 2, symbols 1-3 are associated with RB segments 216B, 216C, and 216D, respectively, having the same first RB segment limits “0” and the same second RB segment limits “240”. Upon determining the one or more combinations of symbols, the first physical layer circuit 220 may be configured to generate, for each combination of symbols of the one or more combinations of symbols, a C-plane message of the C-plane messages 222.

Upon generating the C-plane message for each combination of symbols, the first physical layer circuit 220 may be configured to determine whether the slot 210 includes one or more unanalyzed symbols for which the C-plane message is not generated. In some examples, the unanalyzed symbols may include one or more symbols that are excluded from the one or more combinations of symbols within the slot 210. For the non-limiting example shown in FIG. 2, the first physical layer circuit 220 may determine the symbol ‘0’ and the symbol ‘13’ as the unanalyzed symbols. Since no RB segment is allocated in the symbol ‘13’, the first physical layer circuit 220 may prohibit the generation of the C-plane message for the symbol 13. Conversely, since the RB segment 216A is allocated for the at least one channel in the symbol ‘0’, the first physical layer circuit 220 may generate, for the symbol ‘0’, a C-plane message of the C-plane messages 222. Accordingly, for the non-limiting example shown in FIG. 2, the C-plane messages 222 may include four C-plane messages for the combinations of symbols and/or a single C-plane message for the symbol ‘0’.

In further aspects, upon generating the C-plane messages 222, the first physical layer circuit 220 may be configured to generate a U-plane message for the at least one channel. In various examples, the U-plane message may specify user data for the UEs 110. In further examples, since the C-plane messages 222 specify the aggregated RBG 214 that is allocated for the at least one channel within the slot 210, the U-plane message may not specify unallocated RB segment information for the at least one channel. Accordingly, in some implementations, the first physical layer circuit 220 may generate the U-plane message in such a way that the U-plane message is optimized to not include (or not indicate) the unallocated RB segment information for the at least one channel. As used herein, the unallocated RB segment information may correspond to (refer to) information indicating the remaining RBs, of the resource grid 212, that are excluded from the aggregated RBG 214 (or the plurality of RBGs 214A through 214D).

Upon generating the U-plane message, the second RAN entity 204 may be configured to transmit the C-plane messages 222 (and/or the U-plane message) to the third RAN entity 206. In an example, the first physical layer circuit 220 may be configured to transmit the C-plane messages 222 (and/or the U-plane message) to the third RAN entity 206 via the fronthaul interface. In some aspects, the third RAN entity 206 may include a second physical layer circuit 224. In various examples, the second physical layer circuit 224 may correspond to a circuit (e.g., a chipset, a network card, a processor, a microprocessor, or the like) that is configured to implement one or more protocols associated with a second physical layer (e.g., the low-PHY layer). In numerous examples, the second physical layer circuit 224 may be configured to receive the C-plane messages 222 (and/or the U-plane message) from the second RAN entity 204 (e.g., the first physical layer circuit 220). Upon receiving the C-plane messages 222 (and/or the U-plane message), the second physical layer circuit 224 may be configured to execute the OTA communication with the UEs 110. In some examples, the execution of the OTA communication may include scheduling, based on the C-plane messages 222 and/or the U-plane message, the user data and/or the control information, and transmitting, as per the schedule, the user data and/or the control information to the UEs via the at least one channel.

In this way, the first RAN entity 202 may enable the third RAN entity 206 to execute the OTA communication by transmitting the RB allocation message 218. Further, since the RB allocation message 218 indicates, on the per symbol basis in the slot 210, the at least one RB segment of the plurality of RB segments 216A through 214M, the transmission of the RB allocation message 218 may enable the second RAN entity 204 (e.g., the first physical layer circuit 220) to transmit, to the third RAN entity 206, the C-plane messages 222 that specify the aggregated RBG 214 for the at least one channel. Furthermore, since the C-plane messages 222 specify the aggregated RBG 214 for the at least one channel, the transmission of the C-plane messages 222 may enable the second RAN entity 204 (e.g., the first physical layer circuit 220) to transmit, to the third RAN entity 206, the U-plane message in which the unallocated RB segment information for the at least one channel is absent. Since the unallocated RB segment information is not communicated to the third RAN entity 206 via the fronthaul interface, fronthaul traffic in the fronthaul interface may be reduced, which in turn can enable to improve the network performance, such as network latency, network bandwidth, or the like.

In further aspects, the first RAN entity 202 may be configured to a symbol enable indicator to the second RAN entity 204. In some examples, the symbol enable indicator may be transmitted via the RB allocation message 218. In an example, the symbol enable indicator may correspond to a flag in the RB allocation message 218. For example, the symbol enable indicator may have a first configured value (e.g., a Boolean value of ‘1’) to specify that the RB allocation message 218 indicates the at least one RB segment on the per symbol basis in the slot 210. Additionally, or alternatively, the symbol enable indicator may have a second configured value (e.g., a Boolean value of ‘0’) to specify that the RB allocation message 218 does not indicate the at least one RB segment on the per symbol basis in the slot 210. Accordingly, by transmitting the symbol enable indicator to the second RAN entity 204, the second RAN entity 204 can be made aware of whether the RB allocation message 218 indicates the at least one RB segment on the per symbol basis in the slot 210 or not. As a result, the second RAN entity 204 may operate without performing additional checks, such as determining whether the RB allocation message 218 indicates the at least one RB segment on the per symbol basis in the slot 210 or not. Accordingly, the demand for computation resources of the second RAN entity 204 may be reduced.

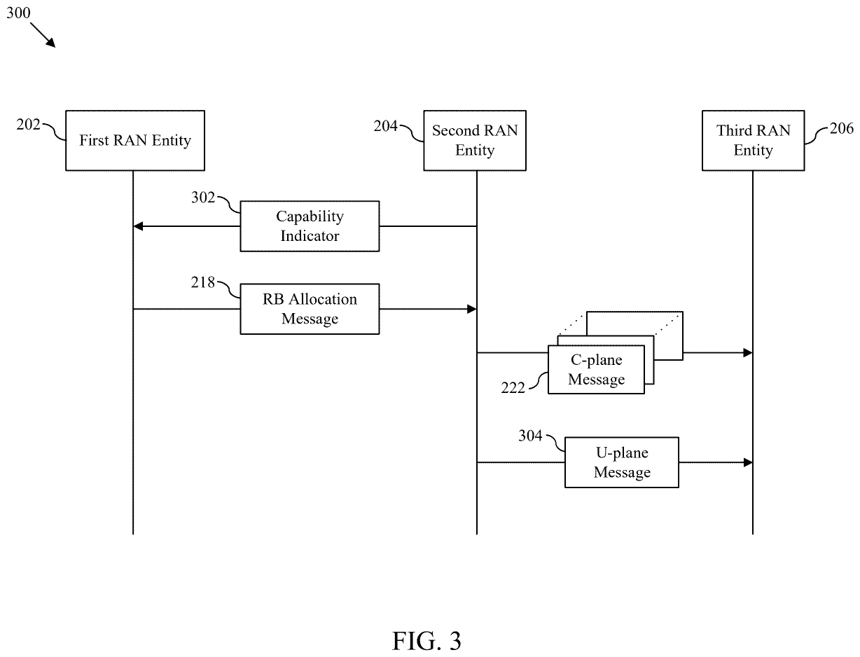

FIG. 3 is a diagram that illustrates an example of a message flow 300 for the fronthaul optimization, in accordance with certain aspects of the present disclosure. FIG. 3 is explained in conjunction with FIG. 1 and FIG. 2. In a non-limiting example shown in FIG. 3, the message flow 300 may include transmitting a capability indicator 302. In numerous examples, the second RAN entity 204 (e.g., the first physical layer circuit 220) may transmit the capability indicator 302 to the first RAN entity 202 (e.g., the L2/L3 circuit 208) via the midhaul interface. In an example, the capability indicator 302 may correspond to a flag in a signal to communicate at least one capability associated with the first physical layer circuit 220. For example, the capability indicator 302 may have the first configured value (e.g., the Boolean value of ‘1’) to specify that the first physical layer circuit 220 (e.g., the first physical layer) supports the RB allocation message 218 indicating the at least one RB segment on the per symbol basis in the slot 210. Additionally, or alternatively, the capability indicator 302 may have the second configured value (e.g., the Boolean value of ‘0’) to specify that the first physical layer circuit 220 (e.g., the first physical layer) does not support the RB allocation message 218 indicating the at least one RB segment on the per symbol basis in the slot 210. Accordingly, by transmitting the capability indicator 302 to the first RAN entity 202, the first RAN entity 202 can be made aware of whether the first physical layer circuit 220 (e.g., the first physical layer) supports the RB allocation message 218.

Upon receiving the capability indicator 302, the first RAN entity 202 may be configured to transmit the RB allocation message 218 to the second RAN entity 204. In numerous examples, if the capability indicator 302 specifies that the first physical layer circuit 220 supports the RB allocation message 218, the L2/L3 circuit 208 (e.g., the MAC layer) may transmit the RB allocation message 218 to the first physical layer circuit 220 (e.g., the first physical layer). In many examples, the RB allocation message 218 may indicate, on the per symbol basis in the slot 210, the at least one RB segment of the plurality of RB segments 216A through 216M.

Upon receiving the RB allocation message 218, the second RAN entity 204 may be configured to transmit the C-plane messages 222 to the third RAN entity 206. In numerous examples, the first physical layer circuit 220 (e.g., the first physical layer) may transmit, based on the RB allocation message 218, the C-plane messages 222 to the second physical layer circuit 224 (e.g., the second physical layer) via the fronthaul interface. In many examples, the C-plane messages 222 may collectively specify the plurality of RB segments 216A through 216M that is allocated for the at least one channel within the slot 210.

Upon transmitting the C-plane messages 222, the second RAN entity 204 may be configured to generate a U-plane message 304 for the at least one channel. In numerous examples, the first physical layer circuit 220 (e.g., the first physical layer) may generate the U-plane message 304 for the at least one channel. In various examples, the U-plane message 304 may specify the user data for the UEs 110. In further examples, since the C-plane messages 222 specify the plurality of RB segments 216A through 216M that is allocated for the at least one channel, the U-plane message 304 may not specify the unallocated RB segment information for the at least one channel. Accordingly, the first physical layer circuit 220 may generate the U-plane message 304 such that the U-plane message 304 is optimized to not include (or not indicate) the unallocated RB segment information for the at least one channel.

Upon generating the U-plane message 304, the second RAN entity 204 may be configured to transmit the U-plane message 304 to the third RAN entity 206. In numerous examples, the first physical layer circuit 220 (e.g., the first physical layer) may transmit the U-plane message 304 to the second physical layer circuit 224 (e.g., the second physical layer) via the fronthaul interface. Further, since the U-plane message 304 is optimized to not include the unallocated RB segment information, the unallocated RB segment information may not be communicated via the fronthaul interface. Consequently, the communication overhead in the fronthaul interface may be reduced which in turn can assist in improving the network performance, such as reducing network latency, increasing network bandwidth, or the like.

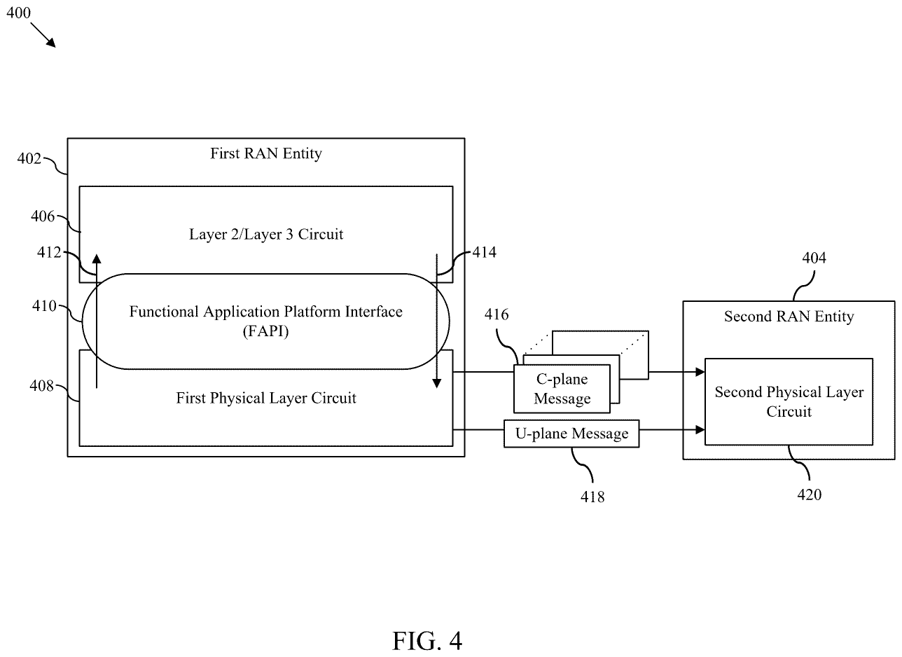

FIG. 4 is a diagram that illustrates an example of an O-RAN 400 for the fronthaul optimization, in accordance with certain aspects of the present disclosure. FIG. 4 is explained in conjunction with FIGS. 1-3. In a non-limiting example shown in FIG. 4, the O-RAN 400 may include a first RAN entity 402 and a second RAN entity 404 that is communicatively coupled to the first RAN entity 402 via the fronthaul interface. In numerous examples, the first RAN entity 402 and the second RAN entity 404 may correspond to the DU 106 and the RU 108, respectively.

In some aspects, the first RAN entity 402 may include an L2/L3 circuit 406 and a first physical layer circuit 408. In an example, the L2/L3 circuit 406 may be configured to implement the MAC protocol of the MAC layer. In other words, the L2/L3 circuit 406 may be configured to function as the MAC layer. The first physical layer circuit 408 may be configured to implement the one or more protocols of the first physical layer. In other words, the first physical layer circuit 408 may be configured to function as the first physical layer (e.g., the high-PHY layer).

Additionally, the first RAN entity 402 may include a FAPI 410. In numerous examples, the FAPI 410 may correspond to an interface, defined by the Small Cell Forum (SCF), that enables communication between the MAC layer and the physical layer in the wireless communication system. In some examples, the FAPI 410 may include a plurality of interfaces, with each interface serving a specific role to enable the communication between the MAC layer and the physical layer. The plurality of interfaces may include a P4 interface, a P5 interface, a P7 interface, and/or a P19 interface. The P4 interface may facilitate network monitoring across multiple generations, such as 4G, 5G, or the like, enabling efficient spectrum analysis and management. The P5 interface may facilitate the physical layer configurations, enabling the small cell to be operational. The P7 interface may facilitate the transmission of per-slot messages or per-subframe messages, enabling the OTA communication. The P19 interface may facilitate network virtualization, enabling a dynamic control for a Frontend Unit (FEU), such as a Digital Front End (DFE) and an Analog Beamforming (ABF).

In some aspects, the first physical layer circuit 408 may be configured to communicate, to the L2/L3 circuit 406, capability information associated with the first physical layer circuit 408. In some examples, to communicate the capability information, the first physical layer circuit 408 may be configured to generate a capability signal 412. In various examples, the capability signal 412 may specify at least one capability associated with the first physical layer circuit 408. In an example, the capability signal 412 may include the capability indicator 302 that specifies whether the first physical layer circuit 408 (e.g., the first physical layer) supports the RB allocation message 218. Upon generating the capability signal 412, the first physical layer circuit 408 may be configured to transmit the capability signal 412 to the L2/L3 circuit 406 via the FAPI 410 (e.g., via the P5 interface of the FAPI 410). In other words, the capability signal 412 may be transmitted from the first physical layer to the MAC layer via the P5 interface of the FAPI 410.

Upon receiving the capability signal 412, the L2/L3 circuit 406 may be configured to determine whether the first physical layer circuit 408 supports the RB allocation message 218. In an example, the L2/L3 circuit 406 may determine whether the capability indicator 302 in the capability signal 412 has the first configured value. For example, if the capability indicator 302 has the first configured value, the L2/L3 circuit 406 may determine that the first physical layer circuit 408 supports the RB allocation message 218.

Upon determining that the first physical layer circuit 408 supports the RB allocation message 218, the L2/L3 circuit 406 may be configured to execute the RB pooling process for the slot 210. Upon executing the RB pooling process, the L2/L3 circuit 406 may be configured to allocate the plurality of RBGs 214A through 214D for the at least one channel within the slot 210. In other words, the plurality of RBGs 214A through 214D may be allocated for the at least one channel at the MAC layer. Upon allocating the plurality of RBGs 214A through 214D, the L2/L3 circuit 406 may be configured to generate a control signal 414 to communicate the plurality of RBGs 214A through 214D allocated for the at least one channel.

In some aspects, to generate the control signal 414, the L2/L3 circuit 406 may be configured to generate the RB allocation message 218 that indicates, on the per symbol basis in the slot 210, the at least one RB segment of the plurality of RB segments 216A through 214M. Upon generating the RB allocation message 218, the L2/L3 circuit 406 may configure the control signal 414 to include the RB allocation message 218 in a FAPI message of the control signal 414. In various examples, the RB allocation message 218 may be included in the FAPI message as an RB aggregation Protocol Data Unit (PDU). In other words, the RB allocation message 218 may correspond to the PDU in the FAPI message. In numerous examples, the FAPI message may correspond to at least one of a Downlink Transmission Time Interval (DL TTI) request message, an Uplink Downlink Control Information (UL DCI) message, or an Uplink Transmission Time Interval (UL TTI) request message.

Upon generating the control signal 414, the L2/L3 circuit 406 may be configured to transmit the control signal 414 to the first physical layer circuit 408 via the FAPI 410 (e.g., via the P7 interface of the FAPI 410). In other words, the control signal 414, including the RB allocation message 218, may be transmitted from the MAC layer to the first physical layer via the P7 interface of the FAPI 410. Upon receiving the control signal 414, the first physical layer circuit 408 may be configured to perform envelope validation for the at least one channel based on the RB allocation message 218.

In some aspects, to perform the envelope validation for the at least one channel, the first physical layer circuit 408 may be configured to determine, based on the RB allocation message 218, the longest RB segment among the plurality of RB segments 216A through 214M. As used herein, the longest RB segment may correspond to (or refer to) an RB segment, of the plurality of RB segments 216A through 214M, whose difference between the first RB segment limit and the second RB segment limit is maximum among the plurality of RB segments 216A through 214M. Upon determining the longest RB segment, the first physical layer circuit 408 may be configured to determine whether the difference between the first RB segment limit and the second RB segment limit of the longest RB segment is lesser than a threshold value.

For example, if the difference is less than the threshold value, the first physical layer circuit 408 may determine that the at least one channel has a valid envelope. Conversely, if the difference is not less than the threshold value, the first physical layer circuit 408 may determine that the at least one channel has an invalid envelope. Upon determining that the at least one channel has the invalid envelope, the first physical layer circuit 408 may transmit a response to the L2/L3 circuit 406. In various examples, the response may indicate that the at least one channel has the invalid envelope. In some more examples, the response may indicate that the L2/L3 circuit 406 is to again perform the RB allocations for the at least one channel.

Upon determining that the at least one channel has the valid envelope, the first physical layer circuit 408 may be configured to generate one or more C-plane messages 416 (collectively referred to as C-plane messages 416) for the at least one channel. The C-plane messages 416 may correspond to the C-plane messages 222 described in the detailed description of FIG. 2. In various examples, the C-plane messages 416 may collectively specify the plurality of RB segments 216A through 214M that is allocated to the at least one channel.

Upon generating the C-plane messages 416, the first physical layer circuit 408 may be configured to transmit the C-plane messages 416 to the second RAN entity 404 via the fronthaul interface. In some aspects, the second RAN entity 404 may include a second physical layer circuit 420. In numerous examples, the second physical layer circuit 420 may be configured to implement the one or more protocols of the second physical layer. In other words, the second physical layer circuit 420 may be configured to function as the second physical layer (e.g., the low-PHY layer). In various examples, the second physical layer circuit 420 may be configured to receive the C-plane messages 416 from the first physical layer circuit 408. In other words, the C-plane messages 416 may be transmitted from the first physical layer to the second physical layer via the fronthaul interface.

Upon transmitting the C-plane messages 416, the first physical layer circuit 408 may be configured to generate a U-plane message 418 for the at least one channel. The U-plane message 418 may correspond to the U-plane message 304 described in the detailed description of FIG. 3. In various examples, in the U-plane message 418, the unallocated RB segment information for the at least one channel may be absent. Upon generating the U-plane message 418, the first physical layer circuit 408 may be configured to transmit the U-plane message 418 to the second RAN entity 404 via the fronthaul interface. In numerous examples, the U-plane message 418 may be transmitted to the second physical layer circuit 420 (e.g., the second physical layer) of the second RAN entity 404. Since the unallocated RB segment information for the at least one channel is absent in the U-plane message 418, the unallocated RB segment information may not be communicated to the second RAN entity 404 via the fronthaul interface. Consequently, the communication overhead in the fronthaul interface may be reduced which in turn can assist in improving the network performance, such as reducing network latency, increasing network bandwidth, or the like.

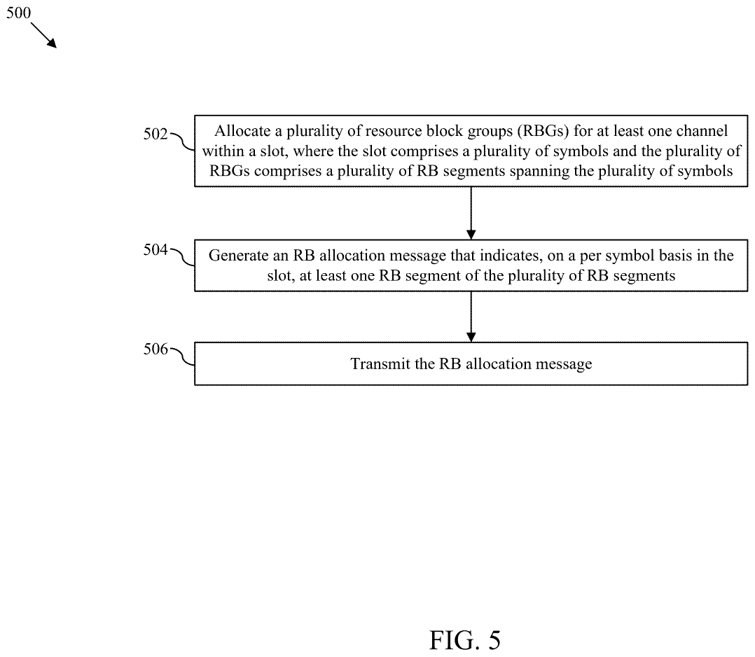

FIG. 5 is a diagram that illustrates a flowchart of a process (e.g., a method) 500 for transmitting an RB allocation message, in accordance with certain aspects of the present disclosure. FIG. 5 is explained in conjunction with FIGS. 1-4. In various examples, the process 500 may be implemented by a RAN entity (e.g., the first RAN entity 202 and/or the first RAN entity 402) for transmitting the RB allocation message (e.g., the RB allocation message 218).

At 502, the plurality of RBGs 214A through 214D may be allocated for the at least one channel within the slot 210. The slot 210 may comprise a plurality of symbols and the plurality of RBGs 214A through 214D may comprise the plurality of RB segments 216A through 216M spanning the plurality of symbols. In several examples, to allocate the plurality of RBGs 214A through 214D, the RAN entity may be configured to execute the RB pooling process for the slot 210. Upon executing the RB pooling process, the RAN entity may be configured to identify the pool of available RBs (e.g., the resource grid 212) for the slot 210. In various examples, the pool of available RBs may include a plurality of RBs that are available for the allocation within the slot 210. As used herein, the slot 210 may refer to (or represent) a time unit that includes the plurality of symbols distributed across multiple sub-carriers. Upon identifying the pool of available RBs, the RAN entity may be configured to allocate, among the pool of available RBs within the slot 210, the plurality of RBGs 214A through 214D for the at least one channel. In some more examples, each RBG of the plurality of RBGs 214A through 214D may include one or more RBs, of the plurality of RBs, that are allocated to a respective UE of the UEs 110 for the at least one channel.

At 504, the RB allocation message 218 may be generated. The RB allocation message 218 may indicate, on the per symbol basis in the slot 210, the at least one RB segment of the plurality of RB segments 216A through 216M. In numerous examples, to generate the RB allocation message 218, the RAN entity may be configured to determine, among the plurality of RB segments 216A through 216M, the at least one RB segment associated with each symbol in the slot 210. Further, the RAN entity may configure the RB allocation message 218 to include the determined at least one RB segment.

At 506, the RB allocation message 218 may be transmitted. In numerous examples, the RAN entity may transmit the RB allocation message 218. In several examples, the RB allocation message 218 may be transmitted from the MAC layer to the first physical layer. Since the RB allocation message 218 indicates, on the per symbol basis in the slot 210, the at least one RB segment of the plurality of RB segments 216A through 214M, the transmission of the RB allocation message 218 may enable the first physical layer to transmit the C-plane messages 222 that collectively specify the plurality of RB segments 216A through 216M. Further, since the C-plane messages 222 specify the plurality of RB segments 216A through 216M, the first physical layer may be enabled to transmit the U-plane message (e.g., the U-plane message 304 and/or the U-plane message 418) in which the unallocated RB segment information for the at least one channel is absent. Consequently, the fronthaul traffic in the fronthaul interface may be reduced, which in turn can assist in improving the network performance, such as reducing network latency, increasing network bandwidth, or the like.

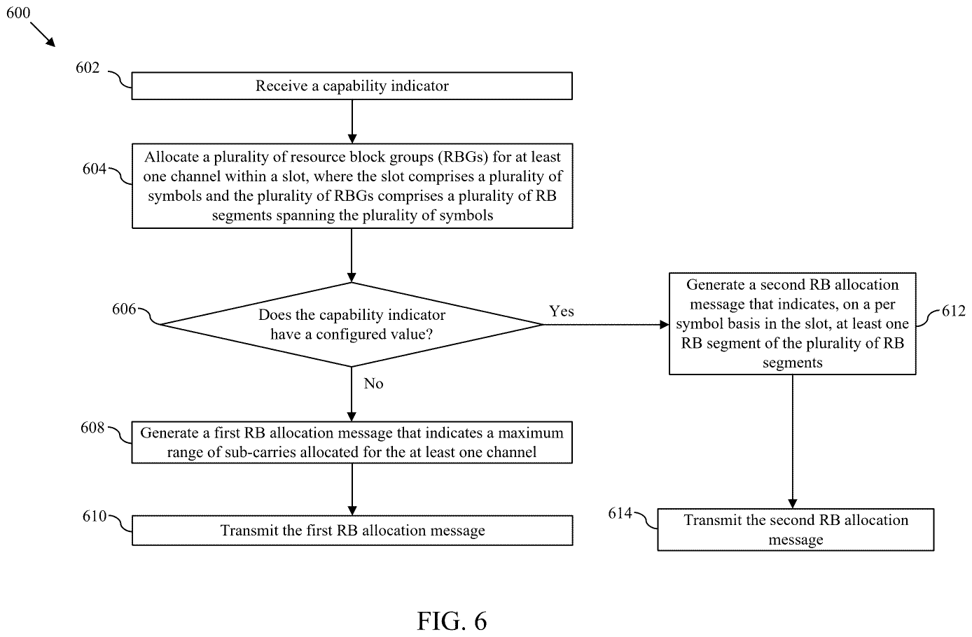

FIG. 6 is a diagram that illustrates a flowchart of a process (e.g., a method) 600 for transmitting one or more RB allocation messages, in accordance with certain aspects of the present disclosure. FIG. 6 is explained in conjunction with FIGS. 1-4. In various examples, the process 600 may be implemented by a RAN entity (e.g., the first RAN entity 202 and/or the first RAN entity 402) for transmitting the one or more RB allocation messages.

At 602, the capability indicator 302 may be received. In numerous examples, the RAN entity may receive the capability indicator 302 at the MAC layer, from the first physical layer. In several examples, the capability indicator 302 may specify whether the first physical layer supports the RB allocation message 218 or not. For example, the capability indicator 302 may correspond to a flag in the capability signal 412. In an example, the capability indicator 302 may have the first configured value to specify that the first physical layer supports the RB allocation message 218. Additionally, or alternatively, the capability indicator 302 may have the second configured value to specify that the first physical layer does not support the RB allocation message 218.

At 604, the plurality of RBGs 214A through 214D may be allocated for the at least one channel within the slot 210. The slot 210 may comprise the plurality of symbols and the plurality of RBGs 214A through 214D may comprise the plurality of RB segments 216A through 216M spanning the plurality of symbols included in the slot 210. In several examples, the RAN entity may allocate the plurality of RBGs 214A through 214D for the at least one channel within the slot 210 by executing one or more dynamic RB allocation processes, such as the RB pooling process. In numerous examples, the allocation of the plurality of RBGs 214A through 214D for the at least one channel may be performed by the RAN entity at the MAC layer.

At 606, the determination of whether the capability indicator 302 has the first configured value may be performed. In numerous examples, the RAN entity may determine whether the capability indicator 302 has the first configured value. If the capability indicator 302 does not have the first configured value, a first RB allocation message may be generated, at 608. The first RB allocation message may indicate a maximum range of sub-carriers allocated for the at least one channel. In numerous examples, the RAN entity may generate the first RB allocation message.

In some aspects, to generate the first RB allocation message, the RAN entity may be configured to determine the longest RB segment among the plurality of RB segments 216A through 216M. As used herein, the longest RB segment may correspond to (or refer to) an RB segment, of the plurality of RB segments 216A through 214M, whose difference between the first RB segment limit and the second RB segment limit is maximum among the plurality of RB segments 216A through 214M. Further, the RAN entity may configure the first RB allocation message to indicate the first RB segment limit and the second RB segment limit of the longest RB segment. Consequently, the first RB allocation message may indicate the maximum range of sub-carriers allocated for the at least one channel.

At 610, the first RB allocation message may be transmitted. In numerous examples, the first RB allocation message may be transmitted from the MAC layer to the first physical layer. In several examples, the RAN entity may transmit the first RB allocation message.

Conversely, if the capability indicator 302 has the first configured value, a second RB allocation message may be generated, at 612. The second RB allocation message may indicate, on the per symbol basis in the slot 210, the at least one RB segment of the plurality of RB segments 216A through 214M. In an example, the second RB allocation message may correspond to the RB allocation message 218 described in the detailed description of FIG. 2. In numerous examples, the RAN entity may generate the second RB allocation message.

At 614, the second RB allocation message may be transmitted. In numerous examples, the second RB allocation message may be transmitted from the MAC layer to the first physical layer. In several examples, the RAN entity may transmit the second RB allocation message. In this way, the process 600 may configure the RAN entity (e.g., the first RAN entity 202 and/or the first RAN entity 402) to transmit, based on the capability indicator 302, the first RB allocation message or the second RB allocation message. Accordingly, if the O-RAN architecture 100 includes one or more RAN entities that do not support the second RB allocation message, the RAN entity may transmit the first RB allocation message to these RAN entities. Consequently, the RAN entity may communicate the RB allocations to the first physical layer without compromising on the network reliability.

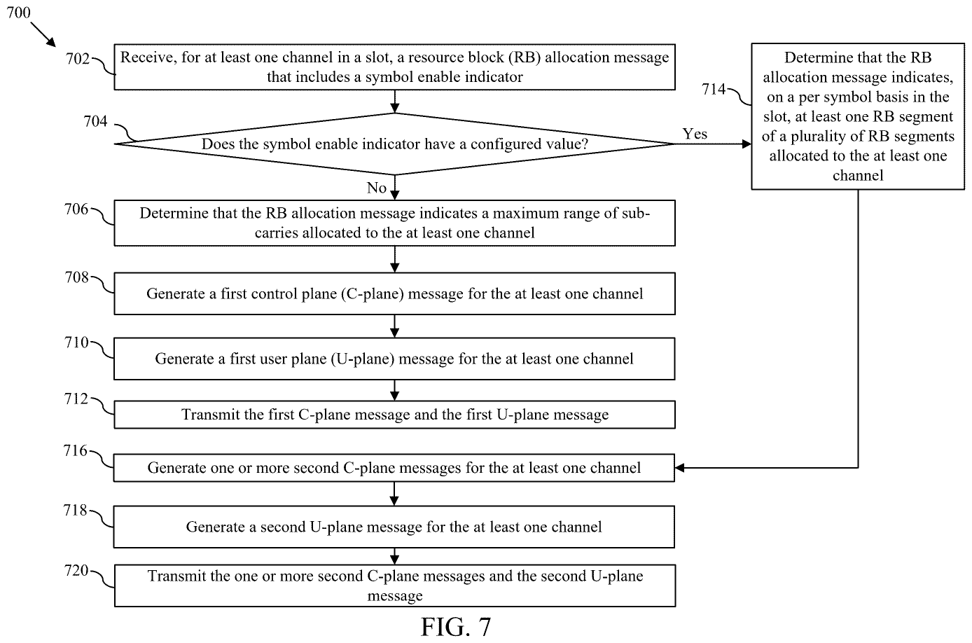

FIG. 7 is a diagram that illustrates a flowchart of a process (e.g., a method) 700 for performing one or more C-plane (and/or U-plane) communications, in accordance with certain aspects of the present disclosure. FIG. 7 is explained in conjunction with FIGS. 1-4. In various examples, the process 700 may be implemented by a RAN entity (e.g., the second RAN entity 204 and/or the first RAN entity 402) for performing the one or more C-plane (and/or U-plane) communications.

At 702, an RB allocation message may be received for the at least one channel within the slot 210. The received RB allocation message may include the symbol enable indicator. In numerous examples, the symbol enable indicator may specify whether the received RB allocation message indicates, on the per symbol basis in the slot 210, the at least one RB segment of the plurality of RB segments 216A through 214M. In an example, the symbol enable indicator may correspond to a flag in the RB allocation message. For example, the symbol enable indicator may have the first configured value to specify that the received RB allocation message indicates, on the per symbol basis in the slot 210, the at least one RB segment of the plurality of RB segments 216A through 214M. Additionally, or alternatively, the symbol enable indicator may have the second configured value to specify that the received RB allocation message does not indicate, on the per symbol basis in the slot 210, the at least one RB segment of the plurality of RB segments 216A through 214M. In other words, the symbol enable indicator may have the second configured value to specify that the received RB allocation message indicates the maximum range of sub-carriers allocated for the at least one channel. In numerous examples, the RAN entity may receive the RB allocation message at the first physical layer, from the MAC layer.

At 704, determination of whether the symbol enable indicator has the first configured value may be performed. In numerous examples, the RAN entity may determine whether the symbol enable indicator has the first configured value. If the symbol enable indicator does not have the first configured value, determination that the RB allocation message indicates the maximum range of sub-carriers allocated to the at least one channel may be performed, at 706. In numerous examples, the RAN entity may determine that the RB allocation message indicates the maximum range of sub-carriers allocated for the at least one channel.

At 708, a first C-plane message for the at least one channel may be generated. In numerous examples, the RAN entity may generate the first C-plane message based on the received RB allocation message. In various examples, the first C-plane message may indicate the maximum range of sub-carriers allocated for the at least one channel.

At 710, a first U-plane message for the at least one channel may be generated. In numerous examples, the RAN entity may generate the first U-plane message. In various examples, the first U-plane message may indicate the unallocated RB segment information for the at least one channel.

At 712, the first C-plane message and the first U-plane message may be transmitted. In numerous examples, the first C-plane message and the first U-plane message may be transmitted from the first physical layer to the second physical layer. In several examples, the RAN entity may transmit the first C-plane message and the first U-plane message.

Conversely, if the symbol enable indicator has the first configured value, determination that the RB allocation message indicates, on the per symbol basis in the slot 210, the at least one RB segment of the plurality of RB segments 216A through 214M allocated to the at least one channel may be performed, at 714. In numerous examples, the RAN entity may determine that the RB allocation message indicates, on the per symbol basis in the slot 210, the at least one RB segment of the plurality of RB segments 216A through 214M. In an example, the first configured value may correspond to the Boolean value of ‘1’.

At 716, one or more second C-plane messages for the at least one channel may be generated. In numerous examples, the generation of the second C-plane messages may be based on the RB allocation message that indicates, on the per symbol basis in the slot 210, the at least one RB segment of the plurality of RB segments 216A through 214M. In some more examples, a second C-plane message of the second C-plane messages may be generated for one of: a symbol in the slot 210, or two or more symbols, in the slot 210, that are associated with the corresponding RB segments, of the plurality of RB segments 216A through 214M, having the same first RB segment limits and same second RB segment limits. In these examples, the second C-plane messages may correspond to the C-plane message 222 described in the detailed description of FIG. 2. In various examples, the RAN entity may generate the second C-plane messages for the at least one channel.

At 718, a second U-plane message for the at least one channel may be generated. In numerous examples, the second U-plane message may include the user data for the UEs 110. In further examples, in the second U-plane message, the unallocated RB segment information for the at least one channel may be absent. In various examples, the RAN entity may generate the second U-plane message.

At 720, the second C-plane messages and the second U-plane message may be transmitted. In numerous examples, the second C-plane messages and the second U-plane message may be transmitted from the first physical layer to the second physical layer. In several examples, the RAN entity may transmit the second C-plane messages and the second U-plane message. In this way, the process 700 may configure the RAN entity (e.g., the second RAN entity 204 and/or the first RAN entity 402) to transmit, based on the symbol enable indicator, the first C-plane message (and/or the first U-plane message) or the second C-plane messages (and/or the second U-plane message).

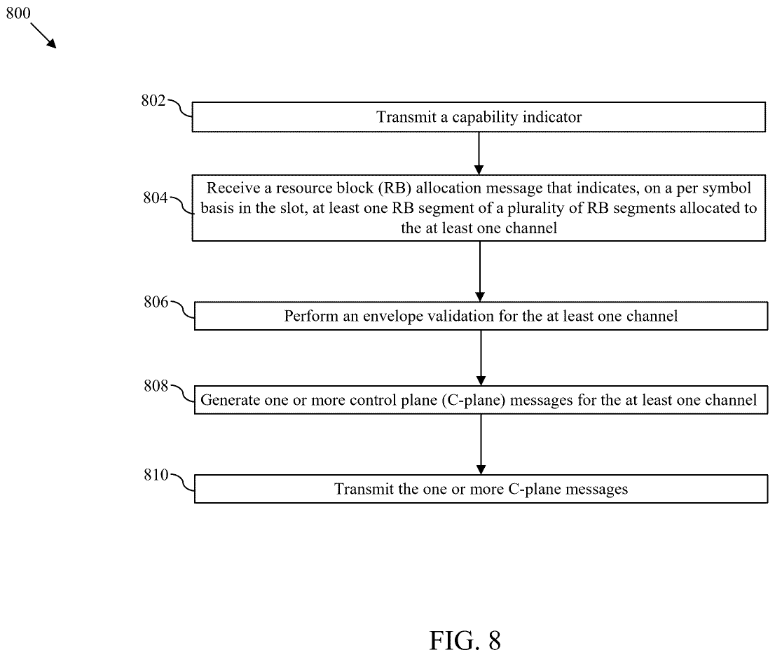

FIG. 8 is a diagram that illustrates a flowchart of a process (e.g., a method) 800 for transmitting one or more C-plane messages, in accordance with certain aspects of the present disclosure. FIG. 8 is explained in conjunction with FIGS. 1-4. In various examples, the process 800 may be implemented by a RAN entity (e.g., the second RAN entity 204 and/or the first RAN entity 402) for transmitting the one or more C-plane messages (e.g., the C-plane messages 222).

At 802, a capability indicator 302 may be transmitted. In numerous examples, the capability indicator 302 may be transmitted from the first physical layer to the MAC layer. In several examples, the RAN entity may transmit the capability indicator 302. In various examples, the capability indicator 302 may specify whether the first physical layer supports the RB allocation message 218 that indicates the at least one RB segment on the per symbol basis in the slot 210. In an example, the capability indicator 302 may have the first configured value to specify that the first physical layer supports the RB allocation message 218. Additionally, or alternatively, the capability indicator 302 may have the second configured value to specify that the first physical layer does not support the RB allocation message 218.

At 804, the RB allocation message 218 for the at least one channel may be received. In numerous examples, the RB allocation message 218 may indicate, on the per symbol basis in the slot 210, the at least one RB segment of the plurality of RB segments 216A through 216M that is allocated to the at least one channel. In various examples, the RB allocation message 218 may be received at the first physical layer, from the MAC layer. In several examples, the RAN entity may receive the RB allocation message 218 based on the transmission of the capability indicator 302 having the first configured value.

At 806, an envelope validation for the at least one channel may be performed. In numerous examples, the RAN entity may perform the envelope validation based on the RB allocation message 218. In some examples, to perform the envelope validation, the RAN entity may be configured to determine, among the plurality of RB segments 216A through 214M indicated by the RB allocation message 218, the longest RB segment. As used herein, the longest RB segment may correspond to (or refer to) an RB segment, of the plurality of RB segments 216A through 214M, whose difference between the first RB segment limit and the second RB segment limit is maximum among the plurality of RB segments 216A through 214M. Upon determining the longest RB segment, the RAN entity may be configured to determine whether the difference between the first RB segment limit and the second RB segment limit of the longest RB segment is lesser than the threshold value. For example, if the difference is less than the threshold value, the RAN entity may determine that the at least one channel has the valid envelope. Conversely, if the difference is not less than the threshold value, the RAN entity may determine that the at least one channel has the invalid envelope.

At 808, the C-plane messages 222 for the at least one channel may be generated. In numerous examples, upon determining that the at least one channel has the valid envelope, the RAN entity may generate the C-plane messages 222 based on the RB allocation message 218. In various examples, the generation of the C-plane messages 222 may be on the per symbol basis in the slot 210. In several examples, the C-plane messages 222 may collectively specify the plurality of RB segments 216A through 214M allocated for the at least one channel.

At 810, the C-plane messages 222 may be transmitted. In numerous examples, the C-plane messages 222 may be transmitted from the first physical layer to the second physical layer via the fronthaul interface. In several examples, the RAN entity may transmit the C-plane messages 222. Since the C-plane messages 222 specify the plurality of RB segments 216A through 214M allocated for the at least one channel, the transmission of the C-plane messages 222 may enable the RAN entity to transmit the U-plane message in which the unallocated RB segment information for the at least one channel is absent. In other words, the transmission of the C-plane messages 222 may enable the RAN entity to prohibit the transmission of U-plane message(s) that include the unallocated RB segment information for the at least one channel. Consequently, the communication overhead in the fronthaul interface may be reduced which in turn can assist in improving the network performance, such as reducing network latency, increasing network bandwidth, or the like.

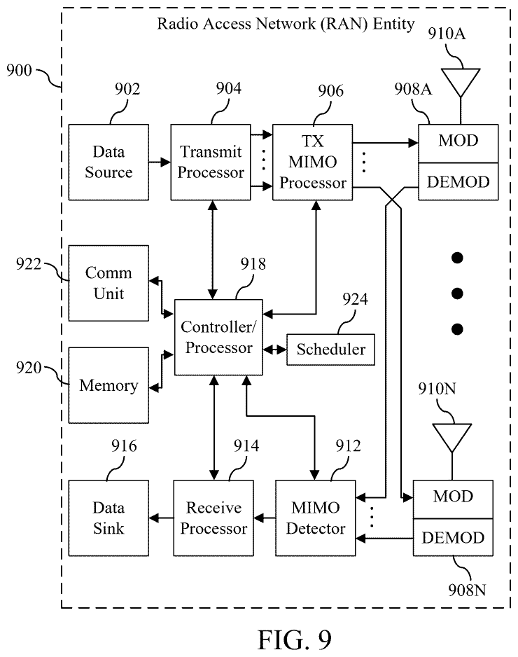

FIG. 9 is a diagram that illustrates an example of a RAN entity 900, in accordance with certain aspects of the present disclosure. FIG. 9 is explained in conjunction with FIGS. 1-8. The RAN entity 900 may facilitate wireless communication with a different RAN entity and/or one or more communication devices (e.g., the UEs 110). In some examples, the RAN entity 900 may correspond to the NR base station, the LTE base station, the eNB, the gNB, the access point, the TRP, or the like.

In some aspects, the RAN entity 900 may include a data source 902 and/or a transmit processor 904. The data source 902 may be configured to generate data intended for a destination device, such as a different RAN entity, the UEs 110, or the like. Further, the data source 902 may output the generated data to the transmit processor 904. The transmit processor 904 may be configured to select one or more modulation and coding schemes (MCSs) for the destination device based on channel quality indicators (CQIs) received from the destination device. Further, the transmit processor 904 may be configured to perform one or more processes (e.g., an encoding process, a modulation process, or the like) on the generated data using the selected MCSs. In some examples, the processes may be performed on the generated data to produce a plurality of data symbols for the destination device.

In some examples, the transmit processor 904 may also process system information (e.g., semi-static resource partitioning information “SRPI”) and/or control information (e.g., channel quality indicator (CQI) requests, grants, or upper-layer signaling) to produce one or more overhead symbols and/or control symbols, respectively. In some more examples, the transmit processor 904 may also produce one or more reference symbols for one or more reference signals or one or more synchronization signals. In an example, the reference signals may include a cell-specific reference signal (CRS), a demodulation reference signal (DMRS), or the like. For example, the synchronization signals may include a primary synchronization signal (PSS), a secondary synchronization signal (SSS), or the like.

In some more aspects, the RAN entity 900 may include a transmit (TX) Multiple-Input Multiple-Output (MIMO) processor 906, a plurality of modems 908A-908N (e.g., ‘N’ modems, where N>1), and/or a plurality of antennas 910A-910N (e.g., ‘N’ antennas or ‘N’ transceivers). The TX MIMO processor 906 may be configured to perform spatial processing (e.g., precoding) on one or more of the data symbols, the overhead symbols, the control symbols, or the reference symbols. In some examples, the spatial processing may be performed to produce a plurality of output symbol streams (e.g., ‘N’ output symbol streams). Further, the TX MIMO processor 906 may be configured to output the plurality of output symbol streams to the plurality of modems 908A-908N. In some aspects, the plurality of modems 908A-908N and the plurality of antennas 910A-910N may be optional or external to the RAN node 900 depending on the functionality of the RAN node 900.

Each modem of the plurality of modems 908A-908N may be configured to receive a respective output symbol stream of the plurality of output symbol streams. Each modem of the plurality of modems 908A-908N may include a modulator component (denoted as “MOD” in FIG. 9) and a demodulator component (denoted as “DEMOD” in FIG. 9). In some examples, the modulator component of each modem may be configured to receive the respective output symbol stream. Further, each modem (e.g., the modulator component) of the plurality of modems 908A-908N may be configured to process the respective output symbol stream to produce a first wireless signal. Consequently, the plurality of modems 908A-908N may produce a plurality of first wireless signals (e.g., a plurality of downlink signals), respectively. Furthermore, the plurality of modems 908A-908N may be configured to transmit the plurality of first wireless signals via the plurality of antennas 910A-910N.

The plurality of antennas 910A-910N may be configured to transmit the plurality of first wireless signals to the destination device. In some examples, the plurality of antennas 910A-910N may include patch antennas, dipole antennas, or the like. In some more examples, the plurality of antennas 910A-910N may be provided within one or more antenna arrays, one or more antenna panels, or the like. In some aspects, the plurality of antennas 910A-910N may be configured to receive, from the destination device, a plurality of second wireless signals (e.g., a plurality of uplink signals). The plurality of second wireless signals may be processed by the plurality of modems 908A-908N. In some examples, the demodulator component of each modem of the plurality of modems 908A-908N may be configured to process a respective second wireless signal of the plurality of second wireless signals.

In further aspects, the RAN entity 900 may include a MIMO detector 912, a receive processor 914, a data sink 916, a controller/processor 918, and/or a memory 920. The MIMO detector 912 may detect the plurality of second wireless signals processed by the plurality of modems 908A-908N. The receive processor 914 may process the detected plurality of second wireless signals to produce decoded data and/or decoded control information. Further, the receive processor 914 may output the decoded data and/or the decoded control information to the data sink 916 and/or the controller/processor 918, respectively. Additionally, the RAN entity 900 may include a communication unit 922 and/or a scheduler 924. The communication unit 922 may correspond to a communication interface that facilitates the RAN entity 900 to communicate to one or more external controllers, such as a network controller, or the like. The scheduler 924 may correspond to an uplink scheduler and/or a downlink scheduler that facilitates the RAN entity 900 to schedule uplink communications and downlink communications, respectively.

In some aspects, the controller/processor 918 may include suitable circuitry, interfaces, and/or logic configured to perform one or more transmitting functions, one or more receiving functions, and one or more processing functions for the RAN entity 900. Examples of the processing functions may include processing signals received and/or to be transmitted by the RAN entity 900. In various aspects, the controller/processor 918 may be implemented with a bus architecture, represented generally by a bus. The bus may include any number of interconnecting buses and bridges depending on the specific application of the controller/processor 918 and the overall design constraints. The bus may provide an interface between the controller/processor 918 and remaining components of the RAN entity 900. For example, the bus may communicatively couple the controller/processor 918 and the memory 920.

Examples of the controller/processor 918 may include, but are not limited to system on a chip (SoC) processors, embedded processors, microcontrollers, specialized Digital Signal Processors (DSPs), Reduced Instruction Set Computing (RISC) processors, Application-Specific Integrated Circuit (ASIC) processors, field-programmable gate arrays (FPGAs), central processing units (CPUs), explicitly parallel instruction computing (EPIC) processors, very long instruction word (VLIW) processors, programmable logic devices (PLDs), state machines, gated logic, discrete hardware circuits, or any suitable processors or circuits configured to perform the various functionality described throughout this disclosure. In further aspects, the controller/processor 918 may be implemented via a baseband or modem chip. In additional implementations, the controller/processor 918 may comprise a number of devices distinct and different from the baseband or modem chip.

In some aspects, the controller/processor 918 may be communicatively coupled to the memory 920 (e.g., computer-readable medium/memory). The memory 920 may include suitable circuitry, interfaces, and/or logic configured to store instructions (e.g., computer-executable code) that when executed by the controller/processor 918 may cause the controller/processor 918 to perform the operations illustrated in FIGS. 1-8, or any operation to perform RB allocation messaging for fronthaul optimization. The RAN entity 900 may store data within the memory 920 by transforming the physical state of one or more physical storage units (e.g., transistors, magnetic domains, optical pits, gate cells, phase change materials, etc.) in the memory 920 to reflect the information being stored. The specific transformation of physical state can depend on various factors. Examples of such factors can include, but are not limited to, the technology used to implement the physical storage units, whether the memory 920 is characterized as primary or secondary storage, and the like.

In further aspects, the memory 920 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, or any suitable medium for storing software and/or instructions that may be accessed and read by a computer.

In some implementations, the RAN entity 900 may be configured to operate as the CU 102, the DU 106, and/or the RU 108 described herein. In some more implementations, the first RAN entity 202, the second RAN entity 204, and/or the first RAN entity 402 described herein may correspond to (or may be included in) the RAN entity 900. For example, the controller/processor 918 or any component of the RAN entity 900 may enable the RAN entity 900 to perform the operations of one or more processes (e.g., the processes 500-800) described herein.

In some aspects, when the RAN entity 900 corresponds to the first RAN entity 202 and/or the first RAN entity 402, the controller/processor 918 or any component of the RAN entity 900 may be configured to allocate the plurality of RBGs 214A through 214D for the at least one channel within the slot 210. The slot 210 may include the plurality of symbols. The plurality of RBGs 214A through 214D may include the plurality of RB segments 216A through 216M spanning the plurality of symbols. Further, the controller/processor 918 or any component of the RAN entity 900 may be configured to generate the RB allocation message 218 that indicates, on the per symbol basis in the slot 210, the at least one RB segment of the plurality of RB segments 216A through 216M. Furthermore, the controller/processor 918 or any component of the RAN entity 900 may be configured to transmit the RB allocation message 218.

In some more aspects, when the RAN entity 900 corresponds to the second RAN entity 204 and/or the first RAN entity 402, the controller/processor 918 or any component of the RAN entity 900 may be configured to receive, for the at least one channel in the slot 210, the RB allocation message 218. The RB allocation message 218 may indicate, on the per symbol basis in the slot 210, the at least one RB segment of the plurality of RB segments 216A through 216M allocated to the at least one channel. The slot 210 may comprise the plurality of symbols and the plurality of RB segments 216A through 216M may span the plurality of symbols. Further, the controller/processor 918 or any component of the RAN entity 900 may be configured to generate the C-plane messages 222 for the at least one channel based on the RB allocation message 218. Furthermore, the controller/processor 918 or any component of the RAN entity 900 may be configured to transmit the C-plane messages 222.

Accordingly, by transmitting (and/or receiving) the RB allocation message 218 that indicates, on the per symbol basis in the slot 210, the at least one RB segment of the plurality of RB segments 216A through 216M, the RAN entity 900 may be enabled to transmit the C-plane messages 222 that collectively specify the plurality of RB segments 216A through 216M allocated to the at least one channel. Further, since the C-plane messages 222 specify the plurality of RB segments 216A through 216M allocated to the at least one channel, the transmission of the C-plane messages 222 may enable the RAN entity 900 to transmit the U-plane message in which the unallocated RB segment information for the at least one channel is absent. In other words, the transmission of the C-plane messages 222 may enable the RAN entity 900 to prohibit the transmission of U-plane message(s) that include the unallocated RB segment information for the at least one channel. Consequently, the communication overhead in the fronthaul interface may be reduced which in turn can assist in improving the network performance, such as reducing network latency, increasing network bandwidth, or the like.

Some implementation examples are described in the following numbered aspects:
Aspect 1: A resource block (RB) allocation method at a Radio Access Network (RAN) entity, the method comprising allocating a plurality of resource block groups (RBGs) for at least one channel within a slot. The slot comprises a plurality of symbols, and the plurality of RBGs comprises a plurality of resource block (RB) segments spanning the plurality of symbols. The method further comprising generating an RB allocation message that indicates, on a per symbol basis in the slot, at least one RB segment of the plurality of RB segments; and transmitting the RB allocation message.
Aspect 2: The method of aspect 1, wherein the RB allocation message indicates, on the per symbol basis in the slot, the at least one RB segment as a function of a first RB segment limit and a second RB segment limit.
Aspect 3: The method of any of aspects 1 through 2, wherein the RB allocation message includes a symbol enable indicator having a configured value to specify that the RB allocation message indicates the at least one RB segment on the per symbol basis in the slot.
Aspect 4: The method of any of aspects 1 through 3, wherein the allocation of the plurality of RBs is at a Medium Access Control (MAC) layer.
Aspect 5: The method of any of aspects 1 through 4, further comprising receiving a capability indicator having a configured value. The configured value specifies that a physical layer supports the RB allocation message indicating the at least one RB segment on the per symbol basis in the slot. The method further comprising transmitting the RB allocation message to the physical layer based on the received capability indicator.
Aspect 6: The method of aspect 5, wherein the reception of the capability indicator and the transmission of the RB allocation message are via a Functional Application Platform Interface (FAPI).
Aspect 7: The method of any of aspects 1 through 6, wherein the RB allocation message corresponds to an RB aggregation Protocol Data Unit (PDU) in a Functional Application Platform Interface (FAPI) message.
Aspect 8: The method of aspect 7, wherein the FAPI message corresponds to at least one of a Downlink Transmission Time Interval (DL TTI) request message, an Uplink Downlink Control Information (UL DCI) message, or an Uplink Transmission Time Interval (UL TTI) request message.
Aspect 9: The method of any of aspects 1 through 8, further comprising generating one or more control plane (C-plane) messages for the at least one channel based on the RB allocation message; and transmitting the one or more C-plane messages to a Radio Unit (RU).
Aspect 10: The method of aspect 9, wherein the generation of the one or more C-plane messages is on the per symbol basis in the slot.
Aspect 11: The method of aspect 9, wherein the generation of a C-plane message in the one or more C-plane messages is for one of two or more symbols in the plurality of symbols that are associated with corresponding RB segments of the plurality of RB segments, wherein the corresponding RB segments have same first RB segment limits and same second RB segment limits; and one symbol in the slot.
Aspect 12: The method of any of aspects 9 through 11, further comprising transmitting, to the RU, a user plane (U-plane) message in which unallocated RB segment information for the at least one channel is absent.
Aspect 13: The method of any of aspects 1 through 12, wherein the RAN entity corresponds to one of a Central Unit (CU) or a Distributed Unit (DU).
Aspect 14: A resource block (RB) allocation method at a Radio Access Network (RAN) entity, the method comprising receiving, for at least one channel in a slot, a resource block (RB) allocation message that indicates, on a per symbol basis in the slot, at least one RB segment of a plurality of RB segments allocated to the at least one channel. The slot comprises a plurality of symbols, and the plurality of RB segments spans the plurality of symbols. The method further comprising generating one or more control plane (C-plane) messages for the at least one channel based on the RB allocation message; and transmitting the one or more C-plane messages.
Aspect 15: The method of aspect 14, wherein the generation of the one or more C-plane messages is on the per symbol basis in the slot.
Aspect 16: The method of aspect 14, wherein the generation of a C-plane message in the one or more C-plane messages is for one of: two or more symbols in the plurality of symbols that are associated with corresponding RB segments of the plurality of RB segments, wherein the corresponding RB segments have same first RB segment limits and same second RB segment limits, or one symbol in the slot.
Aspect 17: The method of any of aspects 14 through 16, further comprising receiving the RB allocation message at a first physical layer, from a Medium Access Control (MAC) layer; and transmitting the one or more C-plane messages to a second physical layer different from the first physical layer.
Aspect 18: The method of aspect 17, further comprising transmitting, to the second physical layer, a user plane (U-plane) message in which unallocated RB segment information for the at least one channel is absent.
Aspect 19: The method of any of aspects 14 through 18, further comprising performing envelope validation for the at least one channel based on the RB allocation message.
Aspect 20: A RAN entity, comprising one or more memories and one or more processors coupled to the one or more memories, the one or more processors individually or collectively configured to cause the RAN entity to perform a method of any of aspects 1 through 13.
Aspect 21: A RAN entity, comprising at least one means for performing a method of any of aspects 1 through 13.
Aspect 22: A non-transitory computer-readable medium storing code for wireless communications in a RAN entity, the code comprising instructions executable by a processor to perform a method of any of aspects 1 through 13.
Aspect 23: A RAN entity, comprising one or more memories and one or more processors coupled to the one or more memories, the one or more processors individually or collectively configured to cause the RAN entity to perform a method of any of aspects 14 through 19.
Aspect 24: A RAN entity, comprising at least one means for performing a method of any of aspects 14 through 19.
Aspect 25: A non-transitory computer-readable medium storing code for wireless communications at a RAN entity, the code comprising instructions executable by a processor to perform a method of any of aspects 14 through 19.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A Radio Access Network (RAN) entity, comprising:
one or more memories; and
one or more processors coupled to the one or more memories, the one or more processors individually or collectively configured to cause the RAN entity to:
allocate a plurality of resource block groups (RBGs) for at least one channel within a slot, wherein
the slot comprises a plurality of symbols, and
the plurality of RBGs comprises a plurality of resource block (RB) segments spanning the plurality of symbols;
generate an RB allocation message that indicates, on a per symbol basis in the slot, at least one RB segment of the plurality of RB segments; and
transmit the RB allocation message.

2. The RAN entity of claim 1, wherein the RB allocation message indicates, on the per symbol basis in the slot, the at least one RB segment as a function of a first RB segment limit and a second RB segment limit.

3. The RAN entity of claim 1, wherein the RB allocation message includes a symbol enable indicator having a configured value to specify that the RB allocation message indicates the at least one RB segment on the per symbol basis in the slot.

4. The RAN entity of claim 1, wherein the allocation of the plurality of RBs is at a Medium Access Control (MAC) layer.

5. The RAN entity of claim 1, wherein the one or more processors are individually or collectively further configured to cause the RAN entity to:
receive a capability indicator having a configured value, wherein the configured value specifies that a physical layer supports the RB allocation message indicating the at least one RB segment on the per symbol basis in the slot; and
transmit the RB allocation message to the physical layer based on the received capability indicator.

6. The RAN entity of claim 5, further comprising a Functional Application Platform Interface (FAPI), wherein the reception of the capability indicator and the transmission of the RB allocation message are via the FAPI.

7. The RAN entity of claim 1, wherein the RB allocation message corresponds to an RB aggregation Protocol Data Unit (PDU) in a Functional Application Platform Interface (FAPI) message.

8. The RAN entity of claim 7, wherein the FAPI message corresponds to at least one of a Downlink Transmission Time Interval (DL TTI) request message, an Uplink Downlink Control Information (UL DCI) message, or an Uplink Transmission Time Interval (UL TTI) request message.

9. The RAN entity of claim 1, wherein the one or more processors are individually or collectively further configured to cause the RAN entity to:
generate one or more control plane (C-plane) messages for the at least one channel based on the RB allocation message; and
transmit the one or more C-plane messages to a Radio Unit (RU).

10. The RAN entity of claim 9, wherein the generation of the one or more C-plane messages is on the per symbol basis in the slot.

11. The RAN entity of claim 9, wherein the generation of a C-plane message in the one or more C-plane messages is for one of:
two or more symbols in the plurality of symbols that are associated with corresponding RB segments of the plurality of RB segments, wherein the corresponding RB segments have same first RB segment limits and same second RB segment limits, or
one symbol in the slot.

12. The RAN entity of claim 9, wherein the one or more processors are individually or collectively further configured to cause the RAN entity to transmit, to the RU, a user plane (U-plane) message in which unallocated RB segment information for the at least one channel is absent.

13. The RAN entity of claim 1, wherein the RAN entity corresponds to one of a Central Unit (CU) or a Distributed Unit (DU).

14. A Radio Access Network (RAN) entity, comprising:
one or more memories; and
one or more processors coupled to the one or more memories, the one or more processors are individually or collectively configured to cause the RAN entity to:
receive, for at least one channel in a slot, a resource block (RB) allocation message that indicates, on a per symbol basis in the slot, at least one RB segment of a plurality of RB segments allocated to the at least one channel, wherein
the slot comprises a plurality of symbols, and
the plurality of RB segments spans the plurality of symbols;
generate one or more control plane (C-plane) messages for the at least one channel based on the RB allocation message; and
transmit the one or more C-plane messages.

15. The RAN entity of claim 14, wherein the generation of the one or more C-plane messages is on the per symbol basis in the slot.

16. The RAN entity of claim 14, wherein the generation of a C-plane message in the one or more C-plane messages is for one of:
two or more symbols in the plurality of symbols that are associated with corresponding RB segments of the plurality of RB segments, wherein the corresponding RB segments have same first RB segment limits and same second RB segment limits, or
one symbol in the slot.

17. The RAN entity of claim 14, wherein the one or more processors are individually or collectively further configured to cause the RAN entity to:
receive the RB allocation message at a first physical layer, from a Medium Access Control (MAC) layer; and
transmit the one or more C-plane messages to a second physical layer different from the first physical layer.

18. The RAN entity of claim 17, wherein the one or more processors are individually or collectively further configured to cause the RAN entity to transmit, to the second physical layer, a user plane (U-plane) message in which unallocated RB segment information for the at least one channel is absent.

19. The RAN entity of claim 14, wherein the one or more processors are individually or collectively further configured to cause the RAN entity to perform envelope validation for the at least one channel based on the RB allocation message.

20. A resource block (RB) allocation method, comprising:
in a Radio Access Network (RAN) entity:
allocating a plurality of resource block groups (RBGs) for at least one channel within a slot, wherein
the slot comprises a plurality of symbols, and
the plurality of RBGs comprises a plurality of RB segments spanning the plurality of symbols;
generating an RB allocation message that indicates, on a per symbol basis in the slot, at least one RB segment of the plurality of RB segments; and
transmitting the RB allocation message.
